(19) United States
(12) Patent Application Publication
(10) Pub. No.: US 2015/0281107 A1
(43) Pub. Date: Oct. 1, 2015

(54) Protocols For Interacting With Content Via Multiple Devices Systems and Methods

(71) Applicant: NANT HOLDINGS IP, LLC, Culver City, CA (US)

(72) Inventor: Timothy C. Dorcey, Santa Monica, CA (US)

(21) Appl. No.: 14/669,495

(22) Filed: Mar. 26, 2015

Related U.S. Application Data
(60) Provisional application No. 61/970,525, filed on Mar. 26, 2014.

(51) Int. Cl. H04L 12/801; H04L 29/06; H04L 12/805

(52) U.S. Cl. CPC H04L 47/35; H04L 47/365; H04L 47/29; H04L 47/14; H04L 65/4069

(57) ABSTRACT

A method of allowing multiple devices to collaborate with content data is presented. The multiple devices can establish an interactive collaboration session via a multimedia protocol. The multimedia protocol allows users of the devices to share chat data, audio data, video data, or other types of data as they collaborate. Additionally, the users of the device can manipulate the content data in shared fashion by submitting one or more asynchronous commands. The commands are multiplexed into the multimedia protocol in a transparent manner. The devices within the group can extract the commands without disrupting the collaboration experience and then execute the commands to affect the content data.

### CROSS-REFERENCE TO RELATED APPLICATIONS

This application relates to and claims the benefit of U.S. Provisional Application No. 61/970,525 filed Mar. 26, 2014 and entitled “PROTOCOLS FOR INTERACTING WITH CONTENT VIA MULTIPLE DEVICES, SYSTEMS AND METHODS,” the disclosure of which is wholly incorporated by reference in its entirety herein.

### STATEMENT RE: FEDERALLY SPONSORED RESEARCH/DEVELOPMENT

Not Applicable

### BACKGROUND

1. Technical Field

The present disclosure is directed to multi-device protocol technologies.

2. Related Art

The background description includes information that may be useful in understanding the present inventive subject matter. It is not an admission that any of the information provided herein is prior art or relevant to the presently claimed invention, or that any publication specifically or implicitly referenced is prior art.

With the massive growth of social media over the last decade, numerous applications have been developed to allow multiple users to interact with each other using mobile devices. An example of a shared media system includes those disclosed by U.S. Pat. No. 7,886,327 to Stevens titled “Media Content Sharing”, filed Apr. 17, 2007. Unfortunately, existing cellular networks are not always conducive to supporting shared, real-time interactive experiences among many devices. One specific problem includes an undesirable latency that users experience when exchanging data over cellular networks.

Traditional approaches to sharing real-time multimedia leverage real-time media and control multiplexing protocols (RTMCMP) where each data type is carried by a separate Internet Protocol (IP) packet. However, as the number of data modalities (e.g., image, video, audio, etc.) increases in a collaborative environment, the per-packet overhead becomes burdensome for the device's communication stack, for the network, and for the user. Further, the efficiency for communication declines due to header bit-rate relative to content bit-rate and due to packet-per-second system events. In other words, the communication stacks of the edge devices must spend more time detecting packets and decoding packets, which increases the latency a user experiences.

Thus, there is still a need for protocols through which multiple devices can collaborate with each other via multimodal data without incurring additional overhead.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

The following description includes information that may be useful in understanding the present inventive subject matter. It is not an admission that any of the information provided herein is prior art or relevant to the presently claimed invention, or that any publication specifically or implicitly referenced is prior art.

In some embodiments, the numbers expressing quantities of ingredients, properties such as concentration, reaction conditions, and so forth, used to describe and claim certain embodiments of the disclosure are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments are approximations, the numerical values set forth in the specific examples are reported as precisely as practicable. The numerical values presented in some embodiments may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the inventive subject matter and does not pose a limitation on the scope of the inventive subject matter otherwise claimed. No language in the specification should be construed as indicating any non-claimed element essential to the practice of the various embodiments of the present disclosure.

Groupings of alternative elements or embodiments disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### BRIEF SUMMARY

The inventive subject matter provides apparatus, systems and methods in which a multiple devices are able to interact with content data at substantially the same time. One aspect of the inventive subject matter includes methods of interacting with content via a set of multiple devices. The methods can include obtaining an initial set of content data on two or more devices from the set of multiple devices. The content data set could include a video file, image file, a live stream, a collection of files, application data, or other types of modal data. The methods can further include establishing an interactive session among the devices via a multimedia protocol that can support sending or receiving varied modalities of data; text, video, or audio for example. The users of the devices can then interact or collaborate with each other via the interactive session and by exchanging multimedia data through an interactive multimedia data stream. The interactive multimedia data can also take on different modalities possibly including chat data, video data, audio data, drawing data, or other types of data. In the contemplated methods, one or more of the devices can obtain a content manipulation command, possibly from a device user, where execution of the command is to be shared among the collaborating devices. For example, one device user might wish to circle or otherwise highlight an object in an image in the content data set so that all participants can observe the referenced object at the same time. The device can construct one or more data packets having a message payload that encodes or otherwise represents the content manipulation command where the data packets are constructed according to the multimedia protocol. Of worthy note, the content manipulation commands are directed to the content data set, which is external to the multimedia protocol or the interactive session. The methods continue by multiplexing the packets having the message payload into the interactive multimedia stream and sending the packets to other devices in the group. The receiving devices extract the content manipulation command from the interactive stream in a seamless fashion without disrupting the users' experience in the collaboration stream. Once extracted, the devices are able to execute the content manipulation commands, thereby affecting the content data on all devices substantially simultaneously and in real-time.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic of a multi-device collaboration ecosystem;

FIG. 2 is a block diagram of multiple devices configured for participation in the multi-device collaboration ecosystem;

FIG. 3 is a flowchart of one embodiment of a method of interacting with content via a set of multiple devices;

FIG. 4 is a data structure diagram of an exemplary packet including a content manipulation command;

FIG. 5 is a data structure diagram of an exemplary packet with multiple content manipulation commands within a message payload;

FIG. 6 is a data structure diagram of an exemplary data link frame with a packet smaller than the frame size encapsulated therein;

FIG. 7 is a data structure diagram of multiple data link frames including a packet with multiple parts distributed across the frames asymmetrically;

FIG. 8 is a data structure diagram of multiple data link frames with multiple parts distributed across the frames symmetrically;

FIG. 9 is a flowchart illustrating logic for packet destination addressing in accordance with one embodiment of the present disclosure;

FIG. 10 is a diagram illustrating an exemplary video encoding output comprised of intra frames (I-frames) and predicted framed (P-frames); and

FIG. 11 is a diagram illustrating an exemplary frame update sequence.

### DETAILED DESCRIPTION

It should be noted that any language directed to a computer should be read to include any suitable combination of computing devices, including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. Further, the disclosed technologies can be embodied as a computer program product that includes a non-transitory computer readable medium storing the software instructions that causes a process or execute the disclosed steps. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges among devices can be conducted over a packet-switched network, the Internet, LAN, WAN, VPN, or other type of packet switched network; a circuit switched network; cell switched network; or other type of network.

One should appreciate that the disclosed techniques provide many advantageous and technical effects including reducing overhead on multi-device communication channels. By multiplexing the content manipulation data into a multimedia protocol already present on the devices, users do not experience latency overhead they would otherwise experience by sending the content manipulation commands or data via one or more separate command or control channels. In this sense, the content manipulation commands piggy back on the multimedia protocol.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of networking the terms “coupled to” and “coupled with” are used euphemistically to mean “communicatively coupled with” where two more devices are able to exchange data over a network, possibly via one or more intermediary devices.

The following discussion presents the inventive subject matter from a broad perspective followed by a more detailed technical description.

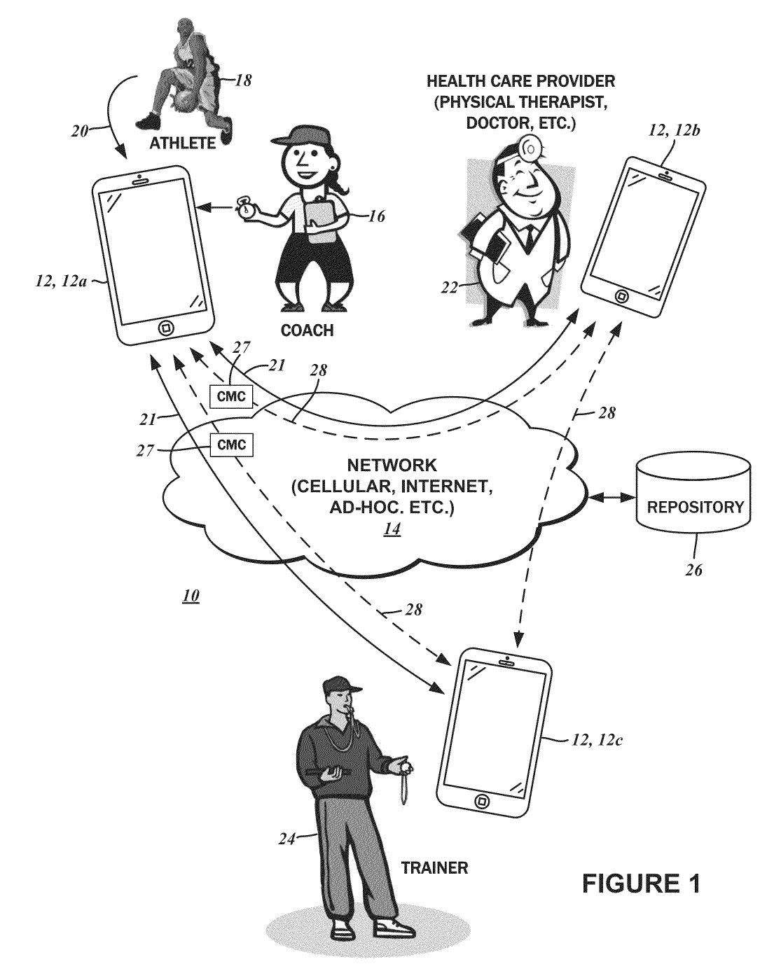

FIG. 1 presents an overview of a possible ecosystem 10 where the disclosed techniques provide for multi-device collaboration with respect to a content data set while the users experience low latency in a shared multimedia session. In the example shown, the devices 12 are represented by smart phones that operate in a peer-to-peer fashion over a network 14 (e.g., cellular network, packet switched network, Bluetooth, P2P, ad-hoc, mesh network, etc.). The example presents the subject matter from a sports perspective. However, it should be appreciated that the disclosed techniques can also be applied to other markets (e.g., education, healthcare, shopping, gaming, medicine, oncology, genomics, military, etc.) without departing from the inventive nature of the technology.

In the example, a coach 16 captures video data of an athlete 18 as a content data set using a first device 12a. The coach 16 wishes to share the video, possibly in real-time subject to inherent network or computational latencies, among her peers; a doctor 22 and a trainer 24 in this case. The doctor 22 may use a second device 12b, while the trainer 24 may use a third device 12c to observe the video. The coach 16 can send the video data 20, or other content data in a set 21, to interested or subscribing parties using conventional techniques (e.g., SMS, MMS, FTP, HTTP, proprietary protocols, etc.). In other scenarios, the devices 12 can obtain the video data 20 from a common repository 26, perhaps a social media site (e.g., Facebook®, Instagram®, etc.), media server, URL, or other on-line source that is also connected to the network 14.

Once the peer devices 12 have obtained the video data 20, the users of the devices can begin collaborating around the video data 20 in a synchronized manner in accordance with various embodiments of the present disclosure. For example, the doctor 22 could time-shift the video data 20 to a desired point in time. In doing so, the doctor's device 12b compiles the time-shifting commands and sends them to the other devices in the ecosystem 10. The other devices 12 can then execute the commands so the users can see and experience the time-shifted video data as the doctor 22 intends. Of particular note, the peers in the ecosystem 10 have established an interactive session protocol thereby reducing latency and overhead in packet processing. Such a system allows the stakeholders in the athlete's career to participate with each other in substantially real-time no matter their location around the world.

Although the example illustrates use of smart phones, it should be appreciated that the group of devices 12 could include a broad spectrum of computing devices. Additional examples of devices include gaming consoles, kiosks, tablets, phablets, appliances, vehicles, or other devices that preferably have a network interface. Further, the group of devices could include a homogenous mix of devices types (e.g., all cell phones) or a heterogeneous mix of device types (e.g., cell phone, hand held gaming devices, vehicles, etc.). For the sake of discussion, the following description will be presented from the perspective of smart phones interacting with each other over a cellular network.

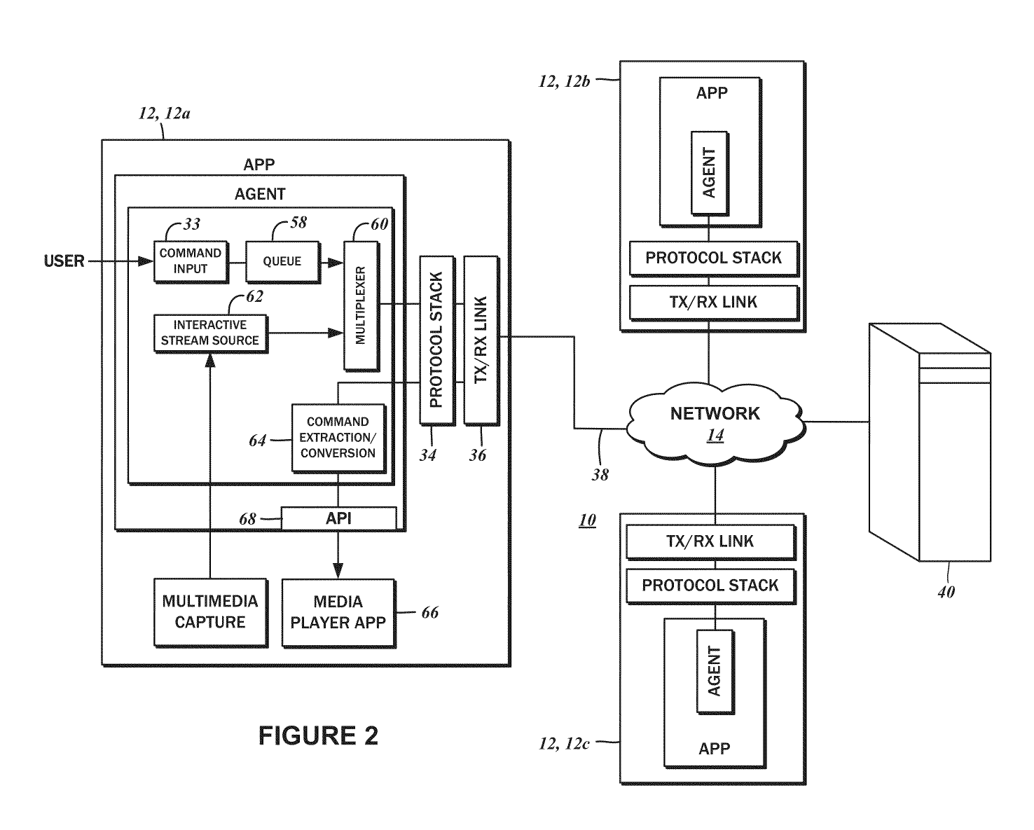

In some embodiments, the inventive subject matter takes on the form of a combination of software and hardware, where the software can be a smart phone app that configures or programs a smart phone or other device (e.g., iPhone®, Android®, Kindle®, iPad®, etc.) to perform the actions associated with the disclosed roles or responsibilities. With reference to the block diagram of FIG. 2, the mobile device 12 may include an app 30 with one or more agents 32 that integrate with multimedia protocols implemented as protocol stack 34, through which users of the phones are able to share interactive multimedia data with each other in substantially real-time; preferably with less than five second latency, more preferably with less than two second latency, yet more preferably with less than one second latency, and still more preferably with less than 500 millisecond latency. For example, the devices 12 can be configured with adapted Facetime® or Skype® applications through which the users can exchange substantially real-time interactive content data sets 21. These software-implemented protocols, in turn, cooperate with hardware transceiver components 36 of the mobile device 12 to establish data links 38 with the network 14 and with other devices 12, for example, the second mobile device 12b and the third mobile device 12c. A new protocol based on UDP is described in more detail below and has the capabilities described herein.

The agent 32 configures or programs the smart phones to operate as peers within the multi-device ecosystem 10. In some embodiments, the devices 12 communicate in a peer-to-peer manner, possibly were the number of devices are small. Some peer-to-peer embodiments also include a name server (not shown) that allows the devices 12 to find or discover each other when they are behind firewalls or they lack a priori known connections. In other embodiments, the devices can communicate through a centralized hub or server 40, which can provide for scaling the group of peers to larger numbers. It should be appreciated that the number of devices 12 in the peer group could be two devices, three devices, ten devices, or more devices as supported by the network or protocols.

The agent 32 has numerous roles or responsibilities with respect to allowing the multiple devices 12 within the peer group to interact with content data sets 21 substantially at the same time, at least to the extent permitted by inherit network or communication latencies. Still, the agent 32 seeks to reduce additional latency overhead by multiplexing content data set commands within the multimedia protocol used for the interactive session.

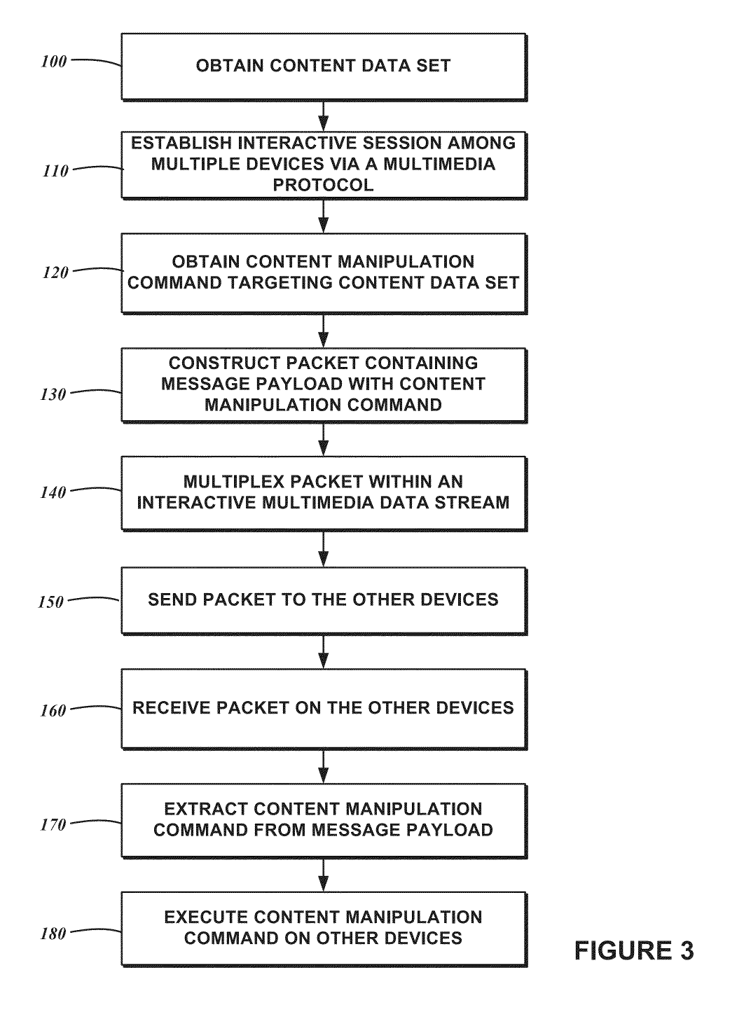

Various embodiments of the present disclosure contemplate a method of interacting with the content data sets 21, and the flowchart of FIG. 3 illustrates one such embodiment. Generally, there is a step 100 of obtaining, by the set of multiple devices 12, the content data set 21. In some embodiments the app 30 or the agent 32 is configured or programmed to send content data sets 21 over the network via a content delivery protocol (e.g., FTP, HTTP, etc.) to one or more of the other devices 12 in the peer group. As shown in the illustration provided in FIG. 1, the coach 16 captures video data 20 of the athlete 18 and sends the video data 20 to the doctor 22 and the trainer 24 as represented by the solid lines passing through the network 14. The content data set itself can comprise a broad spectrum of data modalities possibly including an image file, a video file, a text file, an audio file, a medical record, game data, streaming data, a live data set, a real-time data set, a news feed, on-screen data, application data, biometric data, sensor data, telemetry data, genomic sequence data (e.g., whole genome sequences, exomes, etc.), or other forms of data. The content data set can also include one or more files. Data modalities that vary with time (e.g., audio data, video data, biometric data, application data, etc.) are of special interest because the stakeholders in the peer network are able to time-shift the data to a specific location or time, analyze trends in the data, or otherwise interact with the data based on time.

The devices 12 can exchange content data sets 21 via one or more protocols mentioned previously. For example, the device capturing the content data or operating as the source for the content data (e.g., the first mobile device 12a) could push the data to the other devices via HTTP, FTP, SMS, MMS, TFTP, or other protocols. Alternatively, the content data set 21 can be posted to a media server or social networking site (previously referenced as a common repository 26) for example, from which the peer devices could download the content data set 21. In some embodiments, the source device could notify the peer network that the data is available. Once the other devices in the peer network receive the notification, they can pull the data from the source device or server. Such an approach is considered advantageous because it allows the peer devices to opt out of obtaining the content data due to its size, bandwidth limitations, cost of transfer, or other factors.

The devices 12 in the peer network are able to interact simultaneously with the content data set once their respective agents 32 have access to the content. For the sake of discussion, it is assumed the content data set 21 is stored within the memory of each peer device 12. However, it is contemplated that the content data could also be stored externally to at least some of the peer devices 12. For example, the first one of the peer devices 12a could operate as the repository for all of the other devices 12b, 12c. Rather than sending the full content data set 21, the repository could send only necessary portions (e.g., frames of video, video clips, audio clips, snap shots, etc.) based on received content manipulation commands 27.

Referring again to FIG. 1 as well as to the flowchart of FIG. 3, at least one of the devices 12, possibly more than one, establishes an interactive session over the network 14 via a multimedia protocol 28 among the devices in the group in accordance with a step 110, and is represented by a dashed line in FIG. 1. The multimedia protocol 28 allows the users of the device 12 to interact with each other via their respective apps 30 or agents 32 installed on their devices 12. The multimedia protocol 28 could also take on different forms. Examples include SMS, MMS, chat protocols, or even proprietary protocols. More preferred protocols include those that provide access to their interface to the communication stack (e.g., a TCP/IP, UDP/IP stack). Such protocols are considered advantageous because the agent 32 is able to insert, interleave, or otherwise multiplex additional data within the protocols as discussed in more detail below. Yet more preferred multimedia protocols includes those based on UDP or other simple datagram services that minimizes latency by allowing data loss and can support multiple interactive data modalities exchanged among peer pairs. The multimedia protocol could leverage hub-spoke model, a peer-to-peer model, or a centralized server model.

In further detail, the multimedia protocol 28 comprises a peer-to-peer protocol where each device 12 sends its interactive content data (e.g., chat text, video conference data, voice data, etc.) to the other peers as part of the interactive multimedia data stream. The interactive multimedia data stream does not necessarily have to send data continuously. Rather, that stream need only exchange the interactive data when necessary. As the interactive multimedia data stream receives the interactive data (e.g., chat text, video conference data, audio data, etc.), the interactive data is managed or otherwise governed by the multimedia protocols 28. Thus, the interactive data is presented to the installed app 30 and then locally rendered for consumption by the device's user. The interactive data can also comprise many different data modalities possibly including drawing data, audio data, video data, text data, chat data, haptic data, or other types of data.

The multimedia protocol 28 is preferably constructed to support the exchange of various forms of interactive data and can support corresponding interaction protocols that use the multimedia protocol to transport data. Example protocols that can use the multimedia protocol 28 include a text-based chat protocol, a video protocol, an audio protocol, or a graphic editing protocol, just to name a few. For example, the graphic editing protocol can operate as a transparent overlay canvas present on all devices 12. As canvas commands are sent to all devices 12 in the peer group via the multimedia protocol 28, the canvas commands can then be executed on each device's transparent overlay canvas. Example canvas commands include set color, draw lines, draw text, move text, erase, draw polygon, change line properties, fill area, apply image filter, or other graphic commands.

As an example, consider a scenario as illustrated where the coach 16 sends the video data 20 to the peer group. The doctor 22 could cause a drawing canvas to be instantiated on all the devices 12 and to be overlaid on the presented video. Once the interactive multimedia data stream (e.g., a shared video conference session) has been established, he can time-shift the video data 20 to a specific frame and then mark on the canvas to indicate possible areas of interest in the current frame. The marks appear on all the peer devices' displays in substantially real-time. Further, the doctor 22 can talk to the other stakeholders via video or audio through the interactive session.

As the peer devices 12 interact with each other, in accordance with step 120, their agents 32 obtain one or more content manipulation commands 27 that target the content data, which can be considered data that is external to or independent of the multimedia protocol 28 but in some cases may be transmitted via the multimedia protocol 28. For example, in a limited embodiment where the multimedia protocol 28 comprises a streaming audio teleconferencing protocol, the agent 32 might detect a time-shifting command (e.g., pause, play, fast forward, rewind, stop, etc.) for the video data 20. The time-shifting command is not native to the streaming audio teleconferencing protocol and could represent a completely different data modality from text. Perhaps the time shift commands include haptic data (e.g., accelerometer information) or voice commands. Such commands can be accessible to the device users through the agent 32 or its corresponding overarching app 30, but are typically not a priori supported by or within the multimedia protocol 28. Example content manipulation commands could include a content editing command, a time-shifting command, a create command, a delete command, a file command (e.g., create file, delete file, move file, create directory, etc.), a content capture command, display graphics command, move graphics command, display content for an amount of time, adjust frame rate, or other command that relates to the content data. The commands could be quite complex. As an example, the commands could instruct remote agents to display a rectangular box (e.g., x coordinate, y coordinate, height, width) from a media file (e.g., a file ID) at a frame with a time-stamp (e.g., millisecond), then begin displaying subsequent frames at a specified frame rate (e.g., 0, 1.0×, 1.5×, 2.0×, etc.).

Of particular note, it should be appreciated that the content data set 21 is considered independent of the multimedia protocol 28. Although the multimedia protocol 28 could, in principle, be used to transport the content data set 21 (e.g., file transfer via Skype), the multimedia protocol 28 lacks any inherit control or influence over the content data set 21 once present on the device 12. Rather, the application 30 interacts with the content data set 21.

The agent 32 can obtain the content manipulation command 27 through various techniques. In some embodiments, the agent 32 or its corresponding app 30 can present a user interface offering a menu of content manipulation commands 27. As best shown in FIG. 2, this input may be received by a command input 33. In other embodiments, the user could issue voice commands that are converted through automatic speech recognition (ASR) algorithms to available commands, or through other user interface modalities. Further the agent 32 can filter commands when necessary. For example, the user in control over time-shift might scroll forward in a video then scroll back to a specific frame using a virtual thumb wheel. Rather than sending all time-shifting commands to each device in the group, the local agent could filter conflicting (i.e., scroll forward than back) and only use a time-shifting command that lands on a final desired frame. Each of these functionalities and more may be implemented by the command input 33.

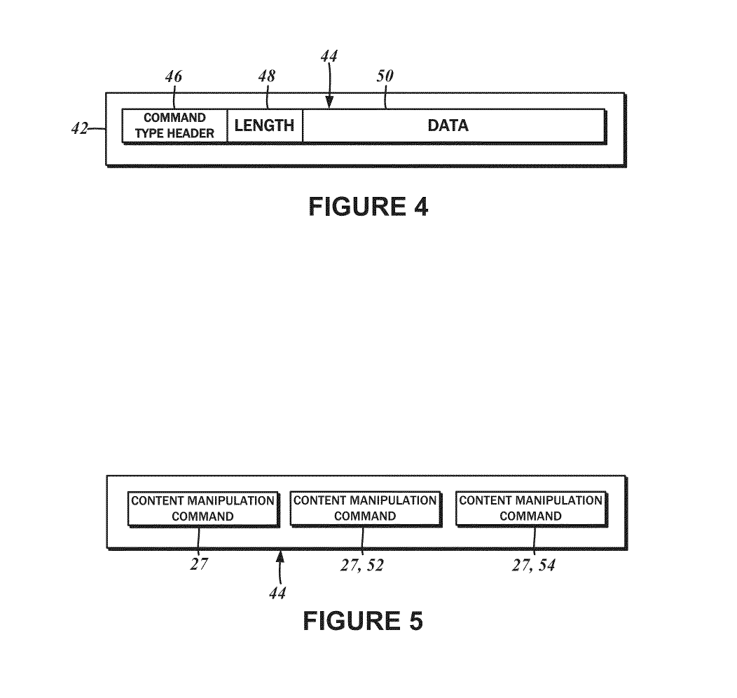

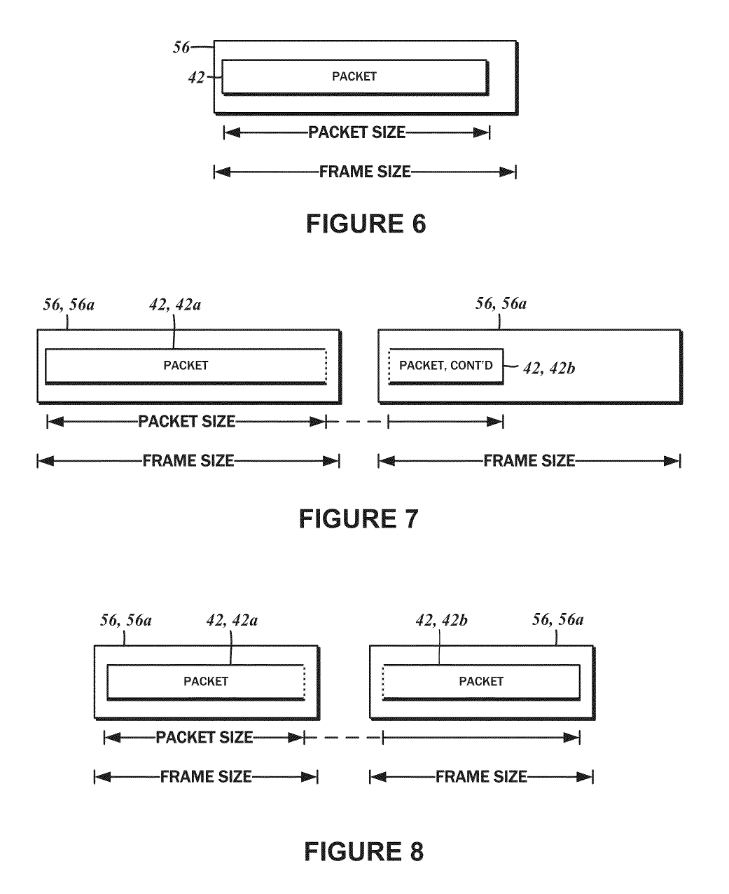

Referring additionally to the exemplary data structure diagram shown in FIG. 4 as well as the flowchart of FIG. 3, in step 130, the agent 32 constructs one or more packets 42 according to the multimedia protocol 28 where the collective packets (e.g., one packet, two packets, etc.) have a message payload 44 that encodes or represents the content manipulation command 27. The message payload 44 encodes the content manipulation command 27 in a manner that is understandable by the other agents in the peer group. For example, the message payload 44 might have a command type header field 46, a length field 48, and a data field 50. The command type header field 46 can be detected by the remote agents 32 which can identify the transmitted command based on the header, length data, and data fields. As shown in the diagram of FIG. 5, in view that a user could submit multiple content manipulation commands 27, the message payload 44 could include multiple commands compiled or aggregated together. Perhaps the user submits content editing commands 52 along with time-shifting commands 54 for example.

The construction of the packets 42 warrants additional attention. Depending on the nature of the multimedia protocol 28, the packets 42 will take on different natures. Of specific interest, in a cellular network, it is advantageous to use packets that respect the underlying frame size of the protocol. Typically each such frame 56 has a size that is around 1500 bytes depending on the link layer. Using frame size as a maximum packet size as shown in FIG. 7 eliminates the need for the internet protocol (IP) layer to fragment or reassemble datagrams, which can incur latency overhead and increased loss probability. Should the content manipulation command 27 exceed the desired packet size (i.e., the message payload exceed a frame size or threshold size) as shown in FIG. 7, then the corresponding message payload will be split or spread across multiple packets 42a, 42b over multiple frames 56a, 56b. Such an approach avoids datagram fragmentation issues or even datagram data corruption issues associated with UDP or IP implementations.

Interestingly, cellular networks are less likely than conventional wired networks to respect packet ordering, and reordering is often related to packet size. For example, if a device sends a first packet of 1400 bytes followed by a second packet of 100 byte, the cellular network will often deliver the second packet first. Thus, packets can be delivered out of order, which forces the communication stack, agent 32, or application 30 to incur additional overhead to reorder the packets, which forces the users to experience additional latency in their collaboration.

In more preferred embodiments, when the content manipulation command 27 or commands exceed the threshold size for a packet 42, as shown in FIG. 8, then the agent 32 constructs at least two packets of substantially equal size (e.g., within 10% of each other, more preferably within 5%, and yet more preferably within 1%). When the packets are nearly equal size, the network will likely deliver then in proper order.

An astute reader will appreciate that the content manipulation commands 27 are granular in nature and if their message payloads 44 are split over multiple packets 42 then loss or delay of any of the multiple packets 42 will cause loss or delay of the entire message. In such scenarios, the agent 32 can adjust the payloads 44 of the packets 42 by shifting portions of the message payload 44 as necessary among packets 42 carrying the interactive multimedia data of the interactive multimedia data stream to balance packet size. This approach is considered advantageous because it provides for respecting preservation of the multimedia data in the stream while preserving the integrity of the message payload 44. For example, in some scenarios the importance of preserving the collaboration interactions, say voice or video exchange for a conversation, exceeds the importance of sending the content manipulation commands 27. Thus, the message payload 44 can be shifted, split, or spread among multiple packets 42 to reduce impact on the interactive multimedia data exchange while also ensuring packets have balanced size, and further ensuring, at least at some level, the message payload 44 maintains the integrity of the content manipulation commands 27. In such cases the packets 42 can include the message payload 44 having the content manipulation commands 27 as well as text data, audio data, video data, acknowledgement data, or other multimedia protocol data. In fact, the disclosed protocol discussed further below supports sending packets 42 that include the content manipulation as well as at least two other types of multimedia data (e.g., text data, audio data, video data, acknowledgement data, etc.).

In other scenarios, it is possible that a packet 42 including the message payload 44 that has the content manipulation command might lack sufficient data to justify the overhead of sending it alone. In such cases, the agent can pad the packet (or packets) with interactive multimedia data from the interactive session. In short, the message payload 44 can be shifted or multiplexed as desired to ensure the interactive session preserves a desirable experience for the users, maintain a packet rate, deliver the commands, and reduce latency.

One of the main responsibilities of the agent 32, in accordance with a step 140 shown in the flowchart of FIG. 3, is to multiplex the packets 42 having the message payload 44 within the interactive stream of the interactive session. In this regard, the agent 32 includes a multiplexer 60 that receives the message payload 44 as generated by the command input 33. It should be appreciated that the agent 32 inserts these constructed packets 42 into the stream as a natural part of the multimedia protocol 28 so that the underlying protocols do not observe any sort of disruption. The agent 32 may have an interactive stream source 62 that serves as a temporary storage of the multimedia protocol data stream. Thus, the agents 32 are able to send or receive the message payloads 44 in a manner that is transparent to the multimedia protocol 28 because the agents 32 can detect the command payload headers 46, 48 embedded in the stream. Further the users do not experience disruption of their collaboration because the content manipulation commands 27 and the corresponding message payloads 44 can be multiplexed in with the interactive multimedia data when bandwidth permits as discussed below with respect to flow control and congestion avoidance.

Once the packets 42 are suitably constructed and the message payloads 44 are multiplexed into the interactive multimedia data stream, the agent 32 can cause the corresponding packets 42 to be sent via the multimedia protocol 28 to the other devices 12 participating in the peer group in a step 150. Depending on the nature of supported data modalities in the multimedia protocol 28, the commands could be converted from a native command format (e.g., a media player command in the form of a binary code) to a supported format (e.g., text format, XML, JSON, YAML, etc.) with suitable framing for detection by the agent 32. Alternatively, the commands could be sent in raw data formats (e.g., raw binary) and framed so that the peer agents can identify and extract the commands from the message payload 44 and can remove the message payloads 44 from the stream to prevent the application layer from receiving the commands.

There are several points of interest with respect to the sending the packets 42. First, the agents 32 can include a message queue 58 that monitors the state of the network among the devices 12 to determine when the message payloads 44 should be sent. The message queue 58 can comprise multiple message payloads 44 that are available to be sent and are stored until there is sufficient bandwidth available with respect to the multimedia protocols 28. For example, if the multimedia protocol supports video conferencing and there is substantial activity in the video stream, the agent might queue message payloads in the message queue 58. When the message queue 58 detects a decrease in activity, it can then submit the stored message payloads 44 for transmission. Thus, the packets 42 can be sent based on the state of the message queue 58 as well as the state of the network.

A second point of interest that should be appreciated is that message payloads 44 in the constructed packets 42 can be sent or received asynchronously relative to sending or receiving the content data set 21. As discussed previously, the content data set 21 is considered independent of or orthogonal to the multimedia protocols 28 so that distribution of the content data set 21 is not impacted by the distribution of the interactive multimedia data via the interactive stream. Therefore, one can consider that the message payloads 44 piggy back on the multimedia protocol 28 when the interactive stream has capacity for the payloads.

A third point of interest is that in some embodiments the peer devices 12 might not have direct connections to each other. For example, in an ad-hoc network or mesh network the peer devices 12 might only have nearest neighbor connections rather than connections to all peers. In scenarios where the peer group lacks direct connections, the agents 32 can include forwarding capabilities where intermediary peer devices 12 can forward the packets having the message payload to its destination. The forwarding capability of the multimedia protocols 28 is discussed in more detail below.

The agents 32 on the other devices receive the constructed packets 42 having the message payloads 44 via the multimedia protocol 28 according to a step 160. In the following description, reference will be made to the same device 12a described above in relation to the packet construction functionality, but it will be appreciated that the following packet deconstruction functionality takes place on the device 12 that receives the data from the first device 12a. Before submitting the data to the upper layers in the app 30 for presentation to the users, the agents 32, and specifically the command extraction and conversion module 64 can intercept the message payloads 44 based on the header or framing information in the payloads 44, and extract the encoded content manipulation commands 27 in a step 170. The extraction process could include converting from one or more of data modalities supported by the multimedia protocol 28 to the data modality for command execution. To continue one of the previous examples, a video time shifting command might be sent over a streaming audio teleconferencing protocol where the command might be sent as text, perhaps as an XML or JSON structure having suitable framing. The command is then converted by the agent 32 from text to a format acceptable to a target video media player. The receiving agents 32 can then send the command to the media player 66 for execution in a step 180, possibly via an application program interface (API) 68.

By providing agents 32 having the disclosed roles or responsibilities, users are able to simultaneously interact with content data without incurring additional latency overhead while also interacting with each other via the interactive session. This disclosed approach allows multiple stakeholders to share their experiences with the content data set in real-time no matter their environmental settings and gives rise interesting capabilities. For example, from the perspective of video annotation or collaboration, users can send recorded videos to other peers in their group and allow multiple parties to manipulate the video in real-time. The users could pan, tilt, zoom, play, pause, step frame-by-frame, do free hand drawing, type text on videos, or otherwise interact with the content while others see the results in real-time. While such manipulations are underway, the users can communicate via live audio or video channels. The above operations can also be recorded, along with voice narration, into a voice over control file, which can be shared and played back at a later time, to replicate the real-time experience asynchronously.

The following discussion provides a more in-depth technical description of the inventive subject matter. More specifically, the disclosed protocols, methods, systems, devices, agents, or other entities represent embodiments of a network protocol that allows for efficient multiplexing of various data types into single IP packets, managed under a common flow control, or congestion avoidance scheme in a multimedia protocol.

The protocol is referred to the real-time media multiplexing protocol (RTMMP) and, at the time of this writing, is being incorporated into new, yet to be released apps.

The RTMMP protocol also supports devices behind firewalls where network address translation (NAT) would typically be required. In the presence of NAT and firewalls, it is often impossible for two clients to address each other directly. In such an embodiment, the disclosed ecosystem 10 can also include a name server or other third party server. For example, the aforementioned central server 40 may be configured as the name server. The devices 12 can connect to the known server address, which then converts the device's identifiers to a destination address. In some embodiments, the server 40 can convert a 32-bit “mmep” ID to a destination address via a look-up table that is kept up-to-date in secure fashion.

The RTMMP ecosystem also supports or aids in enforcing organization of content data. Typically people create content data and then organize the content data. This is approach is referred to as “shoot then file”. The RTMMP helps to enforce organization by encouraging a user to determine where the content should reside (e.g., locally, file folder, social media site, shared peer group, etc.) before capturing the data. This new approach is referred to as “file then shoot”. With apps that support the disclosed RTMMP, for example the TeamHuddle™ app currently under development, one cannot access the camera or other sensor without first choosing a destination for the recording, which can be both a local filing location or a shared location that others can view. In addition to encouraging the discipline of organizing as you go, the app 30 and RTMMP streamlines the work flow when the user anticipates shooting multiple items under a single topic or category. A user can choose the “topic”, perhaps from a drop down list or user created category, then shoot multiple items within it. In this environment, the sensors that capture the content data set 21 can be considered to be virtual devices available for use within the directory, folder, or “topic” in the app 30.

RTMMP has some similarity to real-time transport protocol (RTP), but RTMMP varies fundamentally in numerous ways. One main difference from RTP is that RTMMP uses a basic building block that is a bi-directional stream that contains multiple media types, as well as packet acknowledgements for the stream in the opposite direction. Hence RTMMP is specifically designed for symmetric N-to-N communications, where the maximum value of N depends on the nature of the network. A typical implementation is able to handle up to sixteen devices. Another significant difference is that packets carry destination ID(s) which a downstream forwarding agent can use to route a packet to its final destination(s), possibly on a best-effort basis.

Despite the differences from RTP, contemplated RTMMPs can utilize an RTP v2 header format with repurposed header fields. Thus, the RTMMP protocol could be treated as an RTP profile where the media message payloads can include a multiplexing of media (e.g., user collaboration data), application control data (e.g., content manipulation commands 27) and protocol control data (packet acknowledgements used for flow control and reliability). For example, in RTMMP embodiments, the CSRC (contributing source) array is repurposed. RTP defines the CSRC array to represent the contributing media sources where a mixer component has mixed multiple RTP sources into a single packet. In the RTMMP embodiment, the CSRC array is used to represent the final destination end point(s) for the packet. This approach allows the originating source to send the packet to a downstream forwarding agent, which can maintain a forwarding table or other routing rules by which the end-point ID can be mapped to a next hop IP address. Also, it allows the final endpoint to reject the packet if the end point ID is not valid for itself and no forwarding table exists. This approach also overcomes issues involving the direct addressing of the devices 12 on cellular data networks with certain implementations of NAT such as AT&T where the receiving NAT disallows inbound packets from unsolicited sources. The RTMMP protocol supports an application level gateway to which the devices 12 transmit the packets 42. The application level gateway can initiate a lookup of the 32-bit mmep identifier in a securely maintained table to determine a forwarding IP address. The NAT will allow the packets 42 to the destination devices 12 inbound from the application level gateway because it has already sent a packet thereto.

Media end points are identified by a randomly chosen 32-bit “mmep”, which can be provided to the other end-point by out of band configuration if desired. In addition, both endpoints can share a 128-bit key, which is used to compute a message authentication code (UMAC) that guarantees the authenticity and integrity of protocol header fields, though not application level payload. In particular, the message authentication code prevents an unauthorized party from completing the initial protocol handshake required before any application data will flow. In an N-party scenario, a distinct key is used for each pairwise stream, so there would be N end-point identifiers and N*(N−1)/2 keys.

The RTMMP supports retransmission of packets when reliability is required. However, conventional byte stream reliability, as exemplified by TCP, carries with it the possibility of unbounded delay, which is not appropriate for real-time communications. Hence, we define several message based concepts of reliability, where more recent messages may replace messages that were lost (i.e., rather than retransmitting bytes that are now stale). Communications can be organized into streams of messages, where each message is assigned to one of the following reliability (send_mode) classes:
sm_once: sent once, best effort (used for audio and video frames);
sm_resend: sent repeatedly until acknowledged, or replaced by a more recent sm_resend message from that sender on that stream (used for video initialization frames, which all subsequent video decode frames may depend on being available);
sm_state: sent repeatedly until replaced by a more recent sm_state message from that sender on that stream (used for video decoder acknowledgement data, to let the video encoder know that current state of the decoder);
sm_shared_state: sent repeatedly until acknowledged or replaced by a more recent sm_shared_state message from ANY sender on that stream (used for synchronized photo/video viewing state to identify what portion of which photo/video is currently visible);
sm_shared_state_ack: application level acknowledgement for receipt of sm_shared_state message (used in combination with sm_shared_state to synchronize photo/video viewing); and
sm_stream: a reliable byte stream, like TCP, with all bytes delivered once and in order, and without regard to any “message” boundaries used for photo/video annotation data (drawing and text commands).

The sm_resend and sm_state behaviors are different principally because of their size and frequency. sm_resend is used for sending a large message infrequently (an entire video intra frame encoding). Since an ACK is expected, a loss is assumed after a time-out determined by estimated round trip time. sm_state is used for sending a small message frequently (an acknowledgement that a video frame has been decoded). In this case, new messages are being sent so rapidly that there is little point in acknowledging receipt, because the sender has almost surely advanced to the next message anyway, by the time any such acknowledgement would arrive. On the other hand, in the case where the application generated message flow slows or stops, we want to make sure the recipients receive the most recent message, so it is retransmitted repeatedly, on a schedule set by the application level. The messages are assumed to be small enough that the overhead of unneeded retransmissions is negligible.

sm_shared_state is similar to sm_state, except that all connected parties converge on the same, most recently generated message, regardless of who originated it. The shared viewing has no floor control, so any participant may be attempting to manipulate the shared state, and the most recent action should prevail. Defining “most recent” is ambiguous due to the unknown time lag between the time user A manipulates the state, and the time user B sees that change on their screen. If user B changes the state after they have seen the state user A, then B's state should become the shared state (unless A has meanwhile made another change). Because communication between the transport engine and the presentation layer happens asynchronously, the sm_shared_state_ack allows the application to inform the transport engine what state has actually been seen at presentation layer. If two users are simultaneously manipulating the state, it will frequently be impossible to determine which action was the most recent. In that case, we use the mmep as a tie breaker. That is, the end point with the larger mmep value controls the floor whenever there is a tie.

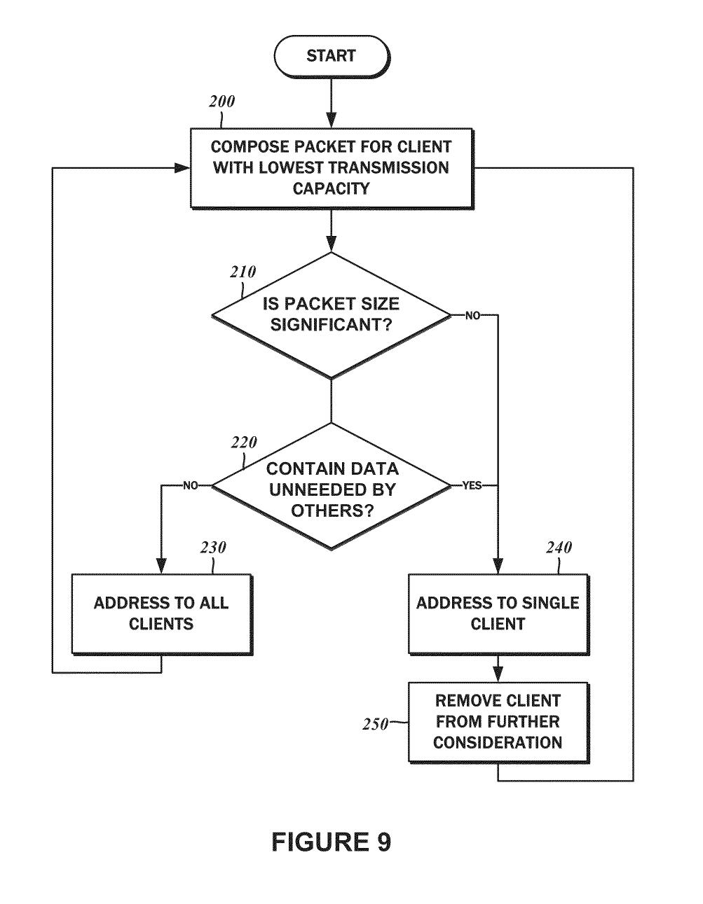

In view that the group of devices 12 can form an ad-hoc network where there is a lack of direct connections, the RTMMP supports multi-party forwarding. In some embodiments, the protocol packet format allows a packet to be addressed to up to 16 destination IDs, by which a media source with limited upstream capacity might send a single packet to a forwarding agent that could replicate and forward the packet to multiple recipients. Alternatively, each outbound packet can be addressed to a single recipient and can be constructed according to the constraints of that destination. To support multiple destinations, the packets can be constructed so that they satisfy the simultaneous constraints of multiple destinations. In general, different destinations will have different network capacity available, so different subsets of packets will need to be addressed to different subsets of recipients. Such logic, as depicted in the flowchart of FIG. 9, could include the following:
1. Compose a packet for the client with the smallest current transmission capacity according to current algorithm for a single recipient (step 200);
2. If the resulting packet is of a meaningful size (decision branch 210), and does not contain too much data not needed by others such as, for example, retransmissions (decision branch 220), then address it to everybody (step 230), and repeat step one; and
3. If the resulting packet is too small (decision branch 210), then just send it to the single recipient (step 240); remove that client from further consideration (step 250), and repeat step one for the remaining clients.

The RTMMP also employs flow control and congestion avoidance. The protocol employs an Additive Increase-Multiplicative Decrease (AIMD) rate control algorithm that is similar to TCP. The number of bytes currently “in flight” (sent but not yet acknowledged or identified as lost) is tracked, and a new transmission is allowed whenever inflight is less than inflight_max, where inflight_max is dynamically adjusted, as follows: when a packet is ACKed, the number of bytes that were inflight at the time it was sent is examined. This number is incremented by a constant (e.g., 512 bytes) and if the resulting value exceeds the current inflight_max, inflight_max is increased to that value. That is, if the agents 32 have seen that inflight bytes can succeed without loss, the agents 32 probe a little higher. When a packet is identified as lost, either because of a timeout or ACK for a later packet, the agents 32 assume there were too many bytes inflight at the time it was sent. In that case, the agents examine how many bytes were inflight at the time it was sent, and reduce that value by some proportional amount, 25% for example. If that value is less than the current inflight_max, inflight_max is reduced to that smaller value.

Furthermore, once the agents 32 recognize that a packet was lost, it means that tracking of how many bytes were inflight for any subsequent packets was incorrect. For example, if the agents 32 sent two 1400 byte packets back-to-back, the agents would record 2800 bytes inflight when the second was sent. However, if the first was lost, then there were actually only 1400 bytes in flight when the second was sent. This is important for how the agents respond to the subsequent ACK or loss of the second packet. A simple correction would remove the bytes now known to be lost from the inflight count for all currently inflight packets. However, if only a single packet was lost, then the ACK of the next few packets already in flight would quickly increase inflight_max back to its previous level, defeating the aim of the multiplicative decrease. A simple heuristic that is effective in practice is to reduce the inflight count associated with each current inflight packet by a multiplicative amount. Hence, if that packet succeeds, the additive increase algorithm resumes from that multiplicatively reduced value. If it is also lost, the multiplicative decrease is compounded.

The RTMMP leverages message priority and queues that can be used by the application 30 when messages are submitted to the communication agent. In some embodiments, each message can be assigned a priority level (e.g., one through four) by the application 30. Due to the dynamically varying rate control and need to minimize latency, it is not feasible for the application to deliver data to the transport engine at exactly the rate the network can support, especially in the case where there are multiple recipients with varying network capacities. By identifying packets which can be dropped with less impact, the application can deliver data to the transport engine at approximately the right rate, and then the transport engine can fine tune the actual transmission rate, on a moment-by-moment and recipient-by-recipient basis, by dropping lower priority packets.

The flow control discussion above is slightly simplified to ignore the effect of message priority. Rather, the transport engine can maintain a separate inflight_max parameter for each of the priority levels, and a message of priority, P, may be transmitted only if the current inflight is less than inflight_max [P]. In effect, the bytes inflight may be restricted to “reserve” capacity for higher priority messages (yet to be delivered to the transport engine). When a packet containing a message with priority P is acknowledged, inflight_max [p] is adjusted for all p>=P by the mechanism described above. When a packet is lost, inflight_max [p] is adjusted for all priorities by the mechanism described above.

As alluded to previously, the message payloads 44 can include numerous types of multimedia data in addition to the content manipulation commands 27. Of particular interest, the packets 42 can include bi-directional acknowledgement data in addition to the content manipulation commands 27. As an example, consider video encoding where the packets can include “IP frame” acknowledgment data in addition to the content manipulation command data.

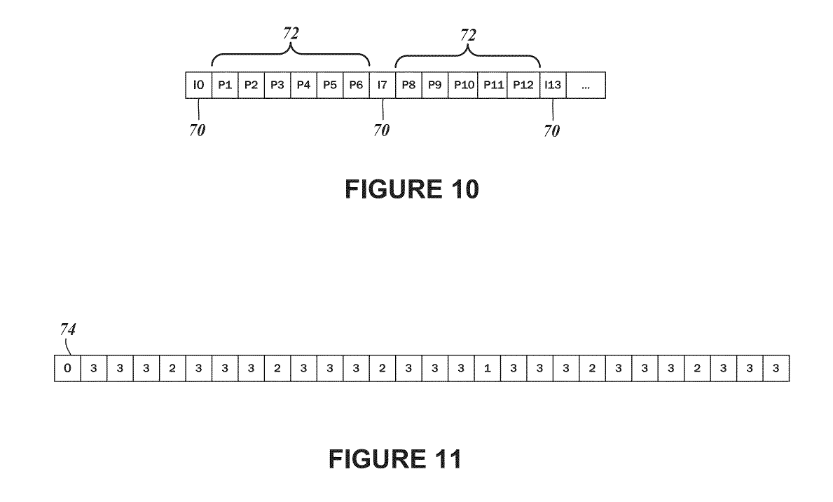

As shown in the diagram of FIG. 10, classic video encoding outputs two distinct types of frame encodings: intra frames (I-frames) 70 that can be decoded without reference to any other frame and predicted frames (P-frames) 72 that depend on the immediately preceding video frame as a basis for prediction. P-frames are typically much smaller than I-frames, often by a factor of 10 or more. However, if a P-frame is lost, then subsequent frames cannot be properly decoded. When the encoding is being transmitted over an unreliable network (e.g., a UDP based network, cellular network, etc.), and real-time latency requirements prohibit retransmission of lost frames, I-frames may be interspersed within the sequence to provide a periodic point of resynchronization.

However, if the encoder was certain that the decoder had received I0, then it could safely encode I7 using I0 as a prediction frame. This could significantly improve efficiency for slowly changing content. Also, reducing the size of the I7 update not only lowers the overall bit rate, but it also reduces the likelihood that it will be lost. That is, a large payload split over many packets increases the likelihood that at least one of the packets will be lost, potentially rendering the entire update unusable.

Hence, considered is a scheme where the I7 update is delayed until the disposition of I0 is known, either by the acknowledgement of its arrival, or by the acknowledgement of a subsequent frame, indicating it was lost. If I0 was received by all target recipients, then I7 is encoded as a P-frame 72, relative to I0. If I0 was lost by at least one recipient, then I7 is sent as an ordinary I-frame. Assuming the I0 was received, and that I7 was encoded relative thereto, as soon as the encoder learns the disposition of this update, it has 2 options to choose from: if the I7 update was lost, it encodes an “IP-frame” relative to I0; otherwise it encodes it relative to I7. Once the first I-frame 70 has been received and acknowledged by all recipients, no further I-frames 70 are necessary. All frame updates are predicted from a previous frame, either classic P-frames 72, or relative to the most recently acknowledged “IP-frame.”

The disclosed RTMMP operating as a multimedia protocol also supports dynamical scalability. When there are multiple recipients for a video stream it is unlikely that all of them can be reached at the same data rate. To avoid adopting a lowest common denominator approach or generating a separate encoding for each recipient, it is helpful if a single encoding can be rescaled to serve different data rates. To achieve temporal scalability, there may be four possible frame types—I0-I3. I0, or importance 0 data frame, is decoded without reference to any previous frame, and hence deemed the most important. I1, or importance 1 data frame, is decoded with reference to the most recent I0 frame. I2, or importance 2 data frame, is decoded with reference to the most recent I1 or I0 frame. Finally, I3, or importance 3 data frame, is decoded with reference to the most recent frame of any type, and deemed the least important.

FIG. 11 illustrates an exemplary frame update sequence 74. If an I3 frame is dropped, proper decoding can resume as soon as the next I2, I1 or I0 arrives. Barring further loss, this will happen within the next 3 frames, so this provides a 4:1 frame rate scaling factor. Dropping I2 frames, provides a 16:1 frame rate scaling. In practice, the system does not drop “all” of any type, but makes these importance levels visible to the network transport engine, so it can fine tune the data rate to each recipient on a frame by frame basis. Also, on the decoding side the agents use this information for CPU scalability, if the decoder is falling behind it can safely discard I3 frames to catch up. In current embodiments, both of the two schemes are combined; letting the Importance I (I1) frames play the role of the “IP-frames” in the acknowledgement scheme, and the 3332332 . . . sequence playing the role of the classic P frames.

The above techniques resolve numerous problems. One of the problems that it resolves is that an application generates a variety of message types (e.g., commands, audio, video, drawing, etc.) that vary in size, frequency, latency requirements, importance, reliability requirements, target recipient(s), or other factors. All of these message types can incur significant overhead in terms of packets per second or latency. The disclosed approach of multiplexing orthogonal command data with interactive collaboration multimedia data allows for sending as much of this data as possible, while minimizing the packet per second rate, subject to a fixed upper bound on the maximum packet size, and not exceeding the currently available network capacity, which could lead to packet loss or excessive buffering delay. Further, the disclosed RTMMP provides feedback to the application layer so it does not generate data at a rate too much higher than can be sent.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of interacting with content via a set of multiple devices comprising:
obtaining, by the set of multiple devices, a content data set;
establishing, by a first device of the set of multiple devices, an interactive session among the multiple devices over a network via a multimedia protocol;
obtaining, by a second device of the set of multiple devices, a content manipulation command targeting the content data set;
constructing, by the second device, according to the multimedia protocol at least one packet having a message payload that having the content manipulation command;
multiplexing, by the second device, the at least one packet within an interactive multimedia data stream of the interactive session;
sending, by the second device, the at least one packet via the multimedia protocol to the other devices of the set of multiple devices;
receiving, by the other devices via the multimedia protocol, the at least one packet with the message payload having the content manipulation command;
extracting, by the other devices, the content manipulation command from the message payload; and
executing, by the other devices, the content manipulation command with respect to the content data set.

2. The method of claim 1, wherein the step of constructing the at least one packet includes constructing more than one packet.

3. The method of claim 2, wherein the message payload is spread among the more than one packet.

4. The method of claim 2, wherein the step of constructing more than one packet includes constructing more than one packet of substantially equal size.

5. The method of claim 4, further comprising adjusting packet payloads of the more than one packet by shifting a portion of the message payload having the content manipulation command from a first packet to a second packet depending on the multimedia data within the interactive multimedia data stream.

6. The method of claim 2, wherein the step of constructing the more than one packet includes padding the more than one packet having the message payload with interactive multimedia data from the interactive multimedia data stream.

7. The method of claim 1, wherein the steps of sending the at least one packet includes asynchronously sending the at least one packet relative to obtaining the content data set.

8. The method of claim 1, wherein the steps of receiving the at least one packet includes asynchronously receiving the at least on packet relative to obtaining the content data set.

9. The method of claim 1, further comprising detecting, by the second device, available bandwidth for the message payload before multiplexing the at least one packet within the interactive stream.

10. The method of claim 1, further comprising a establishing a message control queue at each of the multiple devices.

11. The method of claim 10, wherein the step of sending the at least one packet includes detecting a state of the message queue.

12. The method of claim 10, wherein the step of sending the at least one packet includes sending the packet based on a message priority.

13. The method of claim 1, wherein the at least one packet is sized to fit within at least one link layer data frame.

14. The method of claim 1, wherein the multimedia protocol operates on UDP.

15. The method of claim 1, wherein the first device is the second device.

16. The method of claim 1, wherein the set of multiple devices comprises at least three devices.

17. The method of claim 16, wherein the set of multiple devices comprises at least four devices.

18. The method of claim 1, wherein the content manipulation command comprises at least one of the following: a content editing command, a time-shifting command, a create command, a delete command, a file command, display graphics command, move graphics command, display content for an amount of time, adjust frame rate, and a content capture command.

19. The method of claim 1, wherein the multimedia protocol comprises at least one of the following: a text-based chat protocol, a video protocol, an audio protocol, and a graphic editing protocol.

20. The method of claim 1, wherein the interactive multimedia data stream comprises multimedia data transported by the multimedia protocol.

21. The method of claim 20, wherein the multimedia data includes at least one of the following interactive data modalities: drawing data, audio data, video data, text data, chat data, and haptic data.

22. The method of claim 1, wherein the content data set comprises at least one of the following: an image file, a video file, a text file, an audio file, a medical record, game data, streaming data, a live data set, a real-time data set, a news feed, and on-screen data.

23. The method of claim 1, wherein the network comprises a cellular network.

24. The method of claim 1, wherein the network comprises a packet switched network.

25. The method of claim 1, further comprising forwarding the at least one packet to a destination device by an intermediary device from the set of multiple devices.

26. The method of claim 1, further comprising retransmitting the at least one packet repeatedly based on an application level schedule.

27. The method of claim 1, wherein the at least one packet comprises the content manipulation command and at least two of the following: text data, audio data, video data, and acknowledgement data.
